(19) United States
(12) Patent Application Publication
(10) Pub. No.: US 2026/0236901 A1
(43) Pub. Date: Aug. 13, 2026

(54) PAYMENT COLLECTION SYSTEM WITH CLOSED-LOOP LEARNING, VIRTUAL API INTEGRATION, AND COST-OPTIMIZED PATIENT ENGAGEMENT

(71) Applicant: PATRIOT PAY, LLC, MANCHESTER, NH (US)

(72) Inventor: MATTHEW KAPLAN, GOFFSTOWN, NH (US)

(73) Assignee: PATRIOT PAY, LLC, MANCHESTER, NH (US)

(21) Appl. No.: 19/331,236

(22) Filed: Sep. 17, 2025

Related U.S. Application Data
(60) Provisional application No. 63/695,507, filed on Sep. 17, 2024.

(51) Int. Cl. G06Q 20/10; G06N 20/00; G06Q 20/38

(52) U.S. Cl. CPC G06Q 20/102; G06N 20/00; G06Q 20/389

(57) ABSTRACT

An adaptive payment collection system is disclosed. The system integrates closed-loop learning, wherein each payment attempt and outcome is logged and used to continuously update machine learning models predicting payment likelihood. A cost analysis module links communication costs to expected payment yield, enabling the system to optimize engagement strategies. A novel RPA/OCR virtual API layer provides PMS/EHR integration by retrieving pre-built reports, parsing them into structured data, and posting payments back, enabling rapid onboarding without IT overhead. Preferred embodiments apply in healthcare revenue cycle management to improve patient collections, accelerate revenue, and enhance patient engagement while maintaining HIPAA compliance.

### CROSS REFERENCE TO RELATED APPLICATIONS

This application claims priority to U.S. Provisional Application No. 63/695,507 filed on Sep. 17, 2024, the disclosure of which is incorporated herein by reference in its entirety.

### FIELD OF THE INVENTION

The present invention relates generally to payment collection and processing systems and more particularly, to an adaptive, closed-loop payment system that integrates artificial intelligence (AI) and machine learning (ML) models to predict payment likelihood, optimize communication channel costs, and rapidly integrate with practice management and electronic health record (PMS/EHR) systems through robotic process automation (RPA) and optical character recognition (OCR) techniques.

### BACKGROUND OF THE INVENTION

Patient responsibility balances represent one of the largest sources of uncollected revenue for healthcare providers. Existing systems provide static reports, limited engagement automation, and require lengthy IT integrations. They fail to:
a. Learn dynamically from actual patient payment behavior;
b. Tie communication channel costs (e.g., SMS, IVR, paper, email) to net financial yield; and
c. Onboard providers rapidly without extensive PMS/EHR API projects.

Healthcare organizations thus face delayed revenue cycles, higher collection costs, and lower recovery rates. There is a need for a secure, adaptive, closed-loop payment system that continuously improves predictions, optimizes collection strategies, and enables rapid deployment across heterogeneous PMS/EHR systems.

Medical practice payment and collection systems are generally known in the art. While they can be effective for patient communication and collection, the current systems have no means for analyzing communication costs in relation to the actual payments received, nor for predicting optimal or potential “billed” amounts which are likely to be collected, all of which can lead to improved response rates and better overall collection results. Patient payments are the #1 health care provider revenue opportunity. Providing a system that is secure, informative, flexible & trusted would make it easier for patients to timely pay any amounts owed while at the same time assisting healthcare care providers to quickly and easily recover owed payment amounts.

### SUMMARY OF THE INVENTION

The present invention provides a payment collection system that:
a. Implements closed-loop feedback learning: Each payment attempt (paid, partial, default, delayed) is logged and fed back into ML models, continuously updating predictions;
b. Optimizes communication costs: A policy engine selects engagement channels by comparing predicted payment yield against associated channel costs, maximizing net revenue;
c. Integrates via RPA/OCR virtual APIs: Instead of requiring native PMS/EHR APIs, the system securely logs in, retrieves pre-built reports, parses them into structured data, and posts payments back through automated workflows, enabling onboarding in days, not months; and
d. Maintains compliance and scalability: The architecture is HIPAA-compliant, multi-tenant, and auto-scaling.

Benefits of the system and method according to the present invention include faster collections, reduced cost-per-dollar collected, minimized IT involvement, and improved patient engagement.

According to exemplary embodiments of the invention, an improved payment collection system may integrate artificial intelligence as well as machine and learning models to predict payment confidence and payment cost analysis and to thus optimize customer communication and estimate collection amounts versus collection costs. Specifically, the payment system may be implemented with health care practices to improve collection, patient engagement and patient communication. In addition, although the present invention will be explained using various Amazon Web Services (AWS) products, this is not a limitation of the present invention as other platforms, products and implementations are considered to be within the scope of the present invention.

Objectives of the invention may include:
a) improving payment collection rates by using predictive analytics to identify patients with higher confidence levels in making payments as well as identify patients with lower confidence level in making payments and taking appropriate actions to improve potential payment outcomes;
b) optimizing communication costs by analyzing the cost-effectiveness of particular communication channels, i.e. SMS, Outbound calls and Email notifications, in relation to the payments received from patients; and
(c) identifying optimal “due” amounts based on individual patient metrics which can lead to faster payment and profitable business.

### Proposed Solutions:

a. Payment Confidence Feature

### Machine Learning Models

A. Binary Classification Model: predicts whether a patient is likely to make a payment or not.
   Features: Demographic details (age, gender, location, insurance companies) and historical payment data.
   Algorithm: Logistic regression, decision trees, or ensemble methods
B. Confidence Scoring Model: Assigns a confidence score to each payment prediction.
   Features: Output from the binary classification model and additional features from historical payment behavior.
Algorithm: Regression model, such as linear regression.

The above solutions may provide a dashboard that displays the predicted payment confidence from 0% to 100% where 0% is least likely to pay and 100% is most likely to pay for individual patients, allowing the user to prioritize communication strategies effectively.

The above solutions may also provide real-time predictions about whether a patient is likely to make a payment, so the user can tailor a communication approach according to the specific patient or customer.

The above solutions may still further provide notifications when the payment confidence for a patient changes by a preset amount thereby enabling the user to adjust communication frequency and/or methods in an attempt to secure payment.

### Cost Analysis for SMS and Email Communication Data Collection Feature:

The system may record costs associated with sending SMS and Outbound calls (Twilio), and Email notifications from AWS services so that actual costs may be determined for specific communication channels and provide the ability to adapt communication channels based on prior effectiveness.

### Machine Learning Model

Regression Model: Predict the expected cost of communication based on historical data.

Features: Number of communications sent, type (SMS, Outbound call, Email, paper statements and e-statements), historical cost data of previous communication.

Algorithm: Linear regression or other regression techniques.

The above solution may provide a cost analysis dashboard that provides insights into the expenses associated with all communication channels, helping to optimize communication budgets.

Such a “dashboard” may also provide the ability to see for every payment collected how much the system has spent in a particular communication channel.

### Security and Compliance:

A cloud based secure architecture ensures end-to-end encryption for patient data, payment predictions, and communication cost information and adheres to healthcare data protection standards, such as HIPAA, for fully safeguarding all patient personal data and payment information.

The present invention features a payment collection prediction system utilizing one or more of artificial intelligence as well as machine and learning models to predict payment confidence and payment collection cost analysis and to thus optimize customer communication and estimate collection amounts versus collection costs. In one embodiment, the system and method of the invention are implemented utilizing cloud-based web services such as, but not limited to, Amazon Web Services for example or Microsoft Azure, and Google cloud platform. The system comprises means for retrieving or receiving customer information data related to at least one customer interaction with at least one vendor as well as means for retrieving or receiving billing data related to the at least one customer and the at least one vendor. The system further includes means for retrieving or receiving demographic data related to the at least one customer and means, responsive to the retrieved or received customer information, the retrieved or received billing data and to the retrieved or received demographic data related to the at least one customer, for computing a prediction for the at least one customer to pay the billing data and a predicted cost for collecting a billed amount related to the at least one customer and the at least one vendor.

In another embodiment, the invention features a payment collection prediction method utilizing one or more of artificial intelligence, machine and learning models and feedback loop to predict payment confidence and payment collection cost analysis and to thus optimize customer communication and estimate collection amounts versus collection costs. Recorded factors include how the customer has responded to a particular contact method in the past such as via email, phone text; at what time of day has the customer responded and/or made a payment. By associating this feedback information not only with the customer but to other similarly situated customers (such as for example by sex, age, or other demographic), the system can not only predict probability of customer paying his or her bill but also what is the best means in terms of efficiency and cost to reach the customer. This information can be stored in the customer's profile and also used for like customer initial profiles.

The method comprises retrieving or receiving customer information data related to at least one customer interaction with at least one vendor; retrieving or receiving billing data related to the at least one customer and the at least one vendor; retrieving or receiving demographic data related to the at least one customer; and responsive to the retrieved or received customer information, the retrieved or received billing data and to the retrieved or received demographic data related to the at least one customer, computing a prediction for the at least one customer to pay the billing data related to the at least one customer and the at least one vendor.

In one embodiment, the vendor is a health care provider, and the customer is a patient receiving health care from the health care provider.

In yet another embodiment, the invention features a payment collection prediction system utilizing one or more of artificial intelligence as well as machine and learning models to predict payment confidence and payment collection cost analysis and to thus optimize customer communication and estimate collection amounts versus collection costs. The system comprises a customer information data receiver and data storage device, the customer information data related to at least one customer interaction with at least one vendor, a customer billing data receiver and data storage device, the customer billing data related to the at least one customer and the at least one vendor, and a demographic data receiver and data storage device, the demographic data related to the at least one customer. The system further includes a computerized customer prediction to pay device, responsive to the received and stored customer information data, the received and stored billing data and to the received and stored demographic data, all related to the at least one customer, for computing a prediction for the at least one customer to pay the billing data related to the at least one customer and the at least one vendor.

In this further embodiment, the vendor is a health care provider while the customer is a patient receiving health care from the health care provider.

In summary, the present invention outlines a system for integrating a Payment Confidence feature and a Cost Analysis tool for communication channels into a pre-existing payment processing application. The incorporation of machine learning algorithms ensures that the application not only optimizes payment collection and communication costs but also maintains the highest standards of security and compliance.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWINGS

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a general block diagram of the implemented system architecture;

FIG. 2 is another block diagram of the system architecture;

FIG. 3 is an illustration of an exemplary Dashboard for the system (all practice names, locations and data are fictional samples for illustration);

FIG. 4 is an illustration of an exemplary Patient listing tab (all patient names and data are fictional samples for illustration);

FIG. 5 is an illustration of an exemplary Patient Profile Detail (all patient names and data are fictional samples for illustration);

FIG. 6 is an illustration of an exemplary mobile Payment application screen (all patient names and data are fictional samples for illustration); and

FIG. 7 is an illustration of exemplary data gathered to arrive at the prediction or likelihood of paying a particular balance due by a given patient.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the allowed claims and their legal equivalents. The features illustrated or described in connection with one exemplary embodiment may be combined with the features of other embodiments. Such modifications and variations are intended to be included within the scope of the present disclosure.

Further, in the present disclosure, like-numbered components of the embodiments generally have similar features, and thus within a particular embodiment each feature of each like-numbered component is not necessarily fully elaborated upon. Additionally, to the extent that certain terms are used in conjunction with such systems, devices, and methods, a person skilled in the art will recognize that equivalent terms may exist. A person skilled in the art will recognize that these terms are merely relative to the system and device being discussed and are not universal

The present payment coordination system is a comprehensive healthcare revenue cycle management platform designed to streamline financial processes for medical providers/clinics and hospitals. The platform's primary focus is on managing accounts receivable, organizing activities to maximize collecting payments for services rendered, collecting payment processing, and patient billing related notifications. However, for future it also has the potential to expand into broader data-driven insights and services to optimize revenue cycles and improve patient care.

### Key Features of the System Include:

### 1. Closed-Loop Machine Learning

A transaction logging module records: patient identifier, communication channel, timestamp, requested amount, and payment outcome.
payment Outcome include full payment, partial payment, delayed payment, or non-payment.

Logged payment outcomes are stored in a feature store and used to update the ML prediction models in near real time.

Suitable algorithms include logistic regression, ensemble decision trees, stochastic gradient descent, contextual bandits, or Thompson sampling.

The updated prediction module assigns each account a confidence score (0-100%).

A policy engine applies both the confidence score and channel cost analysis to adapt communication strategy dynamically.

### 2. PMS/EHR Integration-Virtual API Layer

In preferred embodiments, integration with PMS/EHR systems is achieved using a novel RPA/OCR pipeline that:
a. Automates secure login to PMS/EHR;
b. Executes pre-built report exports (balances, transactions, ledgers);
c. Parses flat reports using OCR and coding logic to yield structured, normalized records;
d. Stores said structured data in schemas equivalent to API output; and
e. Posts payments back into PMS/EHR using automated entry workflows.

This creates a virtual API layer, delivering API-like functionality across disparate PMS/EHR vendors, even where APIs are unavailable or restricted.

Advantages include:
f. Onboarding in days instead of months;
g. Minimal IT overhead;
h. Data fidelity equivalent to API integrations; and
i. Bidirectional exchange of balances and payment postings.

### 3. Cost-Optimized Engagement

A cost analysis module computes expected yield per channel:

Eyield(c)−Ppay×ExpectedAmount−CommCost(c)E_{yield}(c)=P_{pay}\times ExpectedAmount−CommCost(c)Eyield(c)=Ppay×ExpectedAmount−CommCost(c)
where PpayP_{pay}Ppay is the predicted likelihood of payment.

The system selects the communication channel(s) maximizing net yield while respecting patient consent, contact frequency limits, and HIPAA rules.

### 4. Security and Compliance

The system ensures:
b. End-to-end encryption (TLS in transit, AES-256 at rest);
c. Role-based access controls (RBAC);
d. Append-only, hash-protected event logs;
e. HIPAA compliance, including Business Associate Agreements (BAAs).

### 5. Scalability and Multi-Tenancy

The system supports multiple tenants (providers) in a segregated environment.

Providers can configure workflows, branding, and reporting.

Auto-scaling cloud infrastructure enables high-volume usage with minimal latency.

### Accounts Receivable Management:

Real-time tracking of outstanding balances.

Detailed breakdown of accounts receivable by patient and service.

Automated reconciliation of payments with patient records.

Seamless Data Compatibility with Practice Management Systems:

Seamless integration with Practice Management Systems (PMS)

Retrieval of financial and billing information, including payment by insurance providers, financial transactions, and open balances.

### Patient Notifications:

Multi-channel patient communication (text, email, phone, paper billing statements).

Customizable notification workflows and escalation options.

Opt-out capability for patients.

Opt-in to traditional paper statements and manual disable function for the practice.

### Data-Driven Insights:

Advanced analytics on revenue cycles, payment statistics, and outstanding balances.

Integration of diagnostic data, insurance data, and treatment data for insights into healthcare operations.

Reporting on insurance turnaround times, revenue breakdowns by diagnosis and treatment type.

Machine learning based predictions impacting tied into analytics and escalations.

### Security and Compliance:

Data encryption at rest and in transit.

Role-based access control using, for example, AWS IAM and Amazon Cognito. AWS (Amazon Web Services) is one non-limiting example of a cloud computing platform used to host and run applications, store data, and provide a wide range of computing services over the internet on a pay-as-you-go basis, rather than businesses needing to purchase and manage their own physical servers and data centers. Key uses include data storage, web and mobile app hosting, gaming platforms, big data analytics, machine learning, IoT, and much more, allowing businesses to scale their IT operations dynamically and innovate quickly.

Compliance with healthcare data protection standards, including HIPAA.

### 6. Scalability and Reliability:

Serverless architecture using, for example, AWS services like Lambda, API Gateway, and Elastic Beanstalk for auto-scaling and high availability.

Disaster recovery planning with, for example, AWS Backup and Recovery services.

### 7. Continuous Integration and Deployment (CI/CD):

Automated deployment pipelines with, for example, AWS CodePipeline and AWS CodeBuild.

Rapid iteration and updates to adapt to evolving business needs.

### Future Growth Potential:

While a minimum Viable Product (MVP) focus is on addressing due amounts and revenue cycle management, the present platform has the potential for significant expansion on the following:

Integration with diagnostic data, insurance data, and prediction to pay data such as patient history data, household data, economic/housing data, social assistance data, community data, credit bureau data, and patient responsibility/balance data for advanced analytics prediction to pay data and analysis.

Providing insights into healthcare operations and optimizing revenue cycles.

Offering consultancy services to clinics and hospitals for optimizing insurance claims processing.

Additional features like reporting for predictive analytics.

### Proposed Architecture

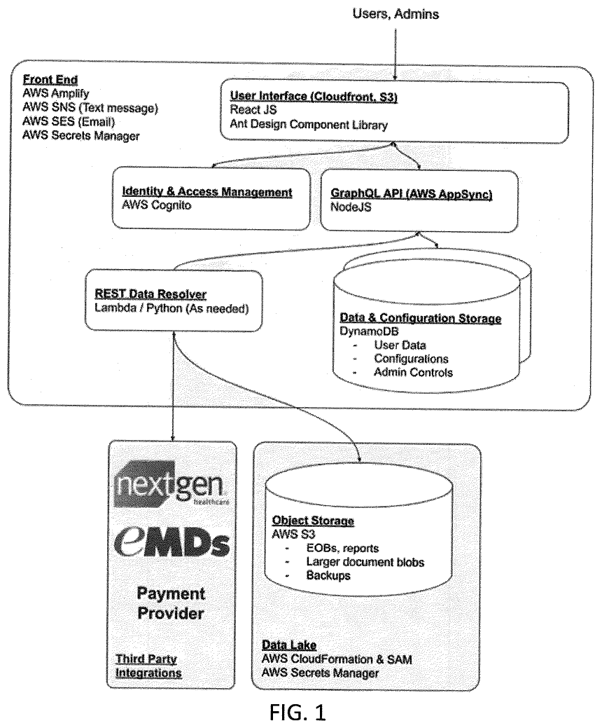

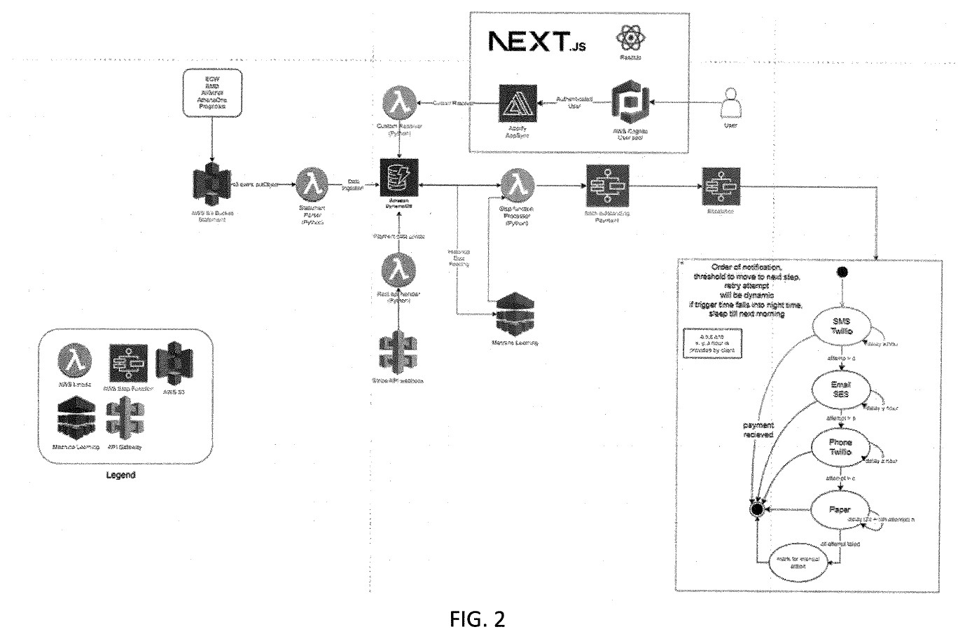

Referring to FIGS. 1 and 2, the proposed architecture for the present payment processing system is designed to provide a comprehensive platform for revenue cycle management and billing services. It leverages various cloud platform computing services such as but not limited to AWS (Amazon Web Services) to ensure scalability, security, and efficiency. Below are the key components and services that constitute the architecture:

### AWS Amplify

AWS Amplify may, for example, be used to build and deploy the application. It provides a set of tools and services that enables front-end web and mobile developers to build secure, scalable full stack applications.

### React (JS)

React may be used for web development, providing a flexible and efficient solution for building user interfaces.

### AWS AppSync

AWS AppSync may, for example, be used to manage and synchronize application data. AWS AppSync enables real-time subscriptions, offline programming features, and data synchronization with built-in conflict resolution.

### REST APIs

Python or Node.js may be used to build REST APIs, providing a robust and scalable solution for server-side development.

### AWS S3

AWS S3 may, for example, be used for storing flat files. AWS S3 provides a scalable and reliable storage solution for our application.

### AWS DynamoDB

A dual storage strategy may preferably but need not necessarily be implemented using, for example, both DynamoDB for application data and Redshift for warehousing and analytics. Existing SQL databases may be converted to a No-SQL architecture (backed by DynamoDB to allow for complete flexibility in the amount of data columns allowable for clients.

### AWS SES

AWS SES may be used, for example, for email services, providing a scalable and cost-effective solution for sending and receiving emails.

### AWS Secrets Manager

AWS Secrets Manager may be used, for example, for secure data storage, protecting access to our applications, services, and IT resources.

The outline below encompasses the initial core features desired, focusing on integrating with various Practice Management Systems, processing financial data, automating notifications, utilizing various inputs to compute prediction to pay for each patient/transaction to try to maximize collection dollars per effort, and providing reporting and reconciliation capabilities. It also highlights multi-tenancy support, ensuring scalability and potential revenue generation by offering the present system to other providers.

### 1. Data Integration and Retrieval (Practice Management Systems):

Fully Data compatible with existing Practice Management Systems (PMS) like Raintree, AthenaHealth, eMDs through APIs for data retrieval.

Obtain financial and billing information data from PMS.

### 2. Base Data Functionality

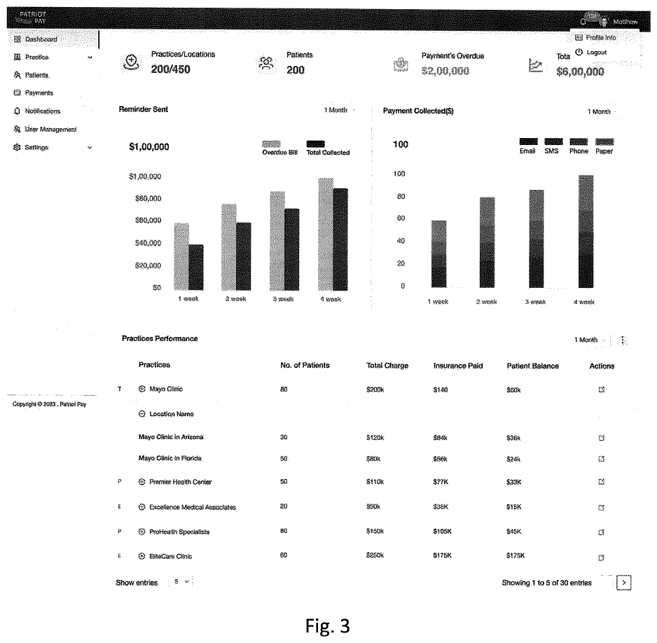

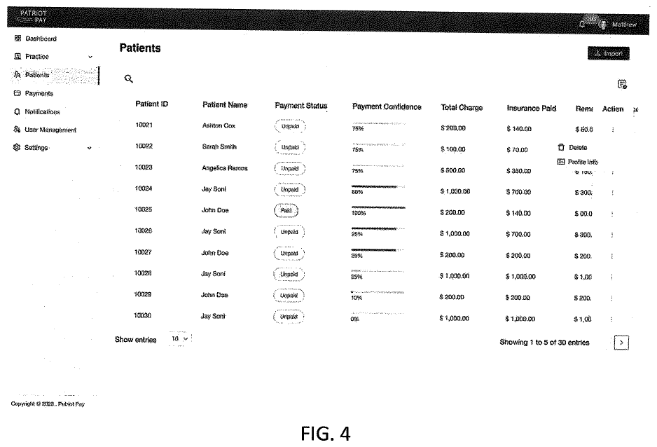

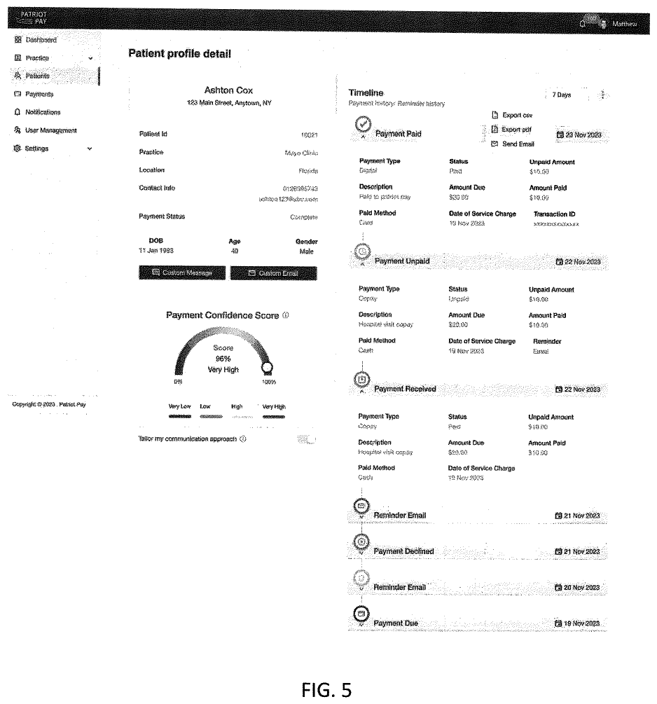

Building a user-friendly portal for clinics and hospitals to access financial and billing information (See FIGS. 3-5 for exemplary portal dashboards, patient listings and patient profile pages).

Processing and formatting the obtained data for further processing.

### 3. Algorithmic Filtering

Implementing filtering and sorting options for users to analyze data by different criteria (e.g., date, amount, insurance provider).

### 4. Patient Notifications:

Sending billing notifications to patients via text, email, phone calls and/or paper billing statements.

Implementing payment escalation options for notifications (e.g., text, email, paper) based on patient responses and/or patient payment history.

### 5. Payment Handling and Options (Optional):

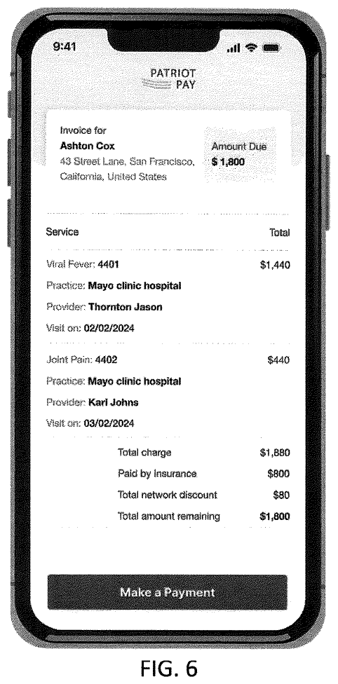

Providing a payment link with no signup is an optional but desirable feature for patients to view and pay their bills without the need to sign up or sign int to any healthcare provider system. (See FIG. 6 for exemplary payment application screen).

### 6. Reconciliation and Reporting:

Scheduling reconciliation reports (daily, weekly, monthly) for internal reporting.

Automating the posting of payments to the Practice Management System to clear patient account balances.

Implementing tracking and reporting based on reconciliation, including analytics on payment statistics.

### 7. Notification Loop and Customization:

Implementing a notification loop for patients who don't pay on time, with customizable intervals and messages.

### 8. Basic Machine Learning

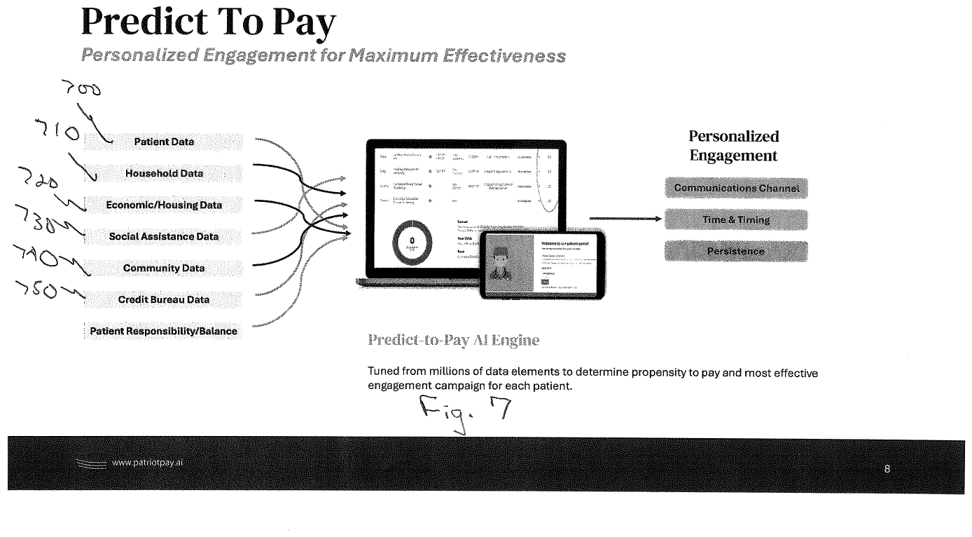

Train a model with data and features to predict the likelihood of patient payment and thus the type and effort that should be placed into payment collections. Patient data and well as personal demographic data and/or city or town demographic data may be used to compute a prediction to pay factor, FIG. 7. Patient historical data 700 is one of the first data elements used to prepare prediction to pay. This data point includes information about the patient such as whether this patient is a long-standing patient of the provider or this is patient coming to the provider as a walk-in to a urgent care clinic. A long-term patient has a higher propensity to pay their bill. Publicly available household data 710 related to the patient including, for example, where a patient lives; does he or she own or rent a home; value of owned home; as well as other factors related to economic housing data for the patient 720 can also be used in the model to compute propensity to pay.

The system may also utilize whether or not the patient is receiving some form of social assistance (Social security or other public assistance) 730 as a data point to compute the patient's propensity to pay. Any relevant community data 740 (community demographic data for example) as well a credit bureau data 750 are also factors that the present system can take into account to compute and predict a patient's likelihood of paying their bill. One additional factor may be the amount of the balance of the requested payment as well as the party responsible for any balance.

All of these factors may be utilized to compute a prediction of a patient's likelihood of paying their balance, which predictor may assist the account holder in deciding how to reach out to the patient; how often (persistence); utilizing what form of contact (phone call, email, text) etc., all in the hopes of increasing the likelihood of timely payment of any outstanding balance by the patient or responsible party.

Ensure the model is measured for accuracy, and continuous updating.

### 9. Multi-Tenancy Support:

Ensuring multi-tenancy support to enable other providers to use the present system independently for their revenue cycle management needs.

White labeled notification messages per account.

### 10 MVP Deployment and Testing:

Deploying the MVP version of Patriot Pay for use by clinics and providers.

HIPAA Verification and Checklist

### Technical Considerations

### Multi-Tenancy

Multi-tenancy ensures that the platform can securely and efficiently serve multiple clients (tenants) while keeping their data segregated. Here are some technical considerations and strategies for implementing multi-tenancy in the system:

### 1. Data Isolation:

For data isolation each tenant should have its own isolated data store, preventing data leakage between tenants. There should be use of separate database schemas, tables, or even databases for each tenant's data.

AWS RDS (Relational Database Service): Utilize separate RDS instances, schemas, or databases for each tenant. AWS RDS provides robust isolation options for data storage.

### 2. Authentication and Authorization:

Implementation of robust authentication and authorization mechanisms to ensure that each user can only access data associated with their respective tenant.

AWS Cognito: Implement user authentication and authorization using AWS Cognito. It allows you to manage user identities and control access to resources.

### 3. Tenant Configuration:

Developing a configuration management system that allows each tenant to customize settings, notifications, and workflows according to their needs.

AWS Secrets Manager: Store tenant-specific configuration data securely using AWS Secrets Manager. This ensures that sensitive configuration settings are isolated and protected.

### 4. Scalability:

Designing the platform to be highly scalable to accommodate a growing number of tenants and users.

AWS Auto Scaling: Configure auto-scaling for Patriot Pay components to handle increased load efficiently. AWS Auto Scaling dynamically adjusts resources based on demand.

### 5. Performance Isolation:

Ensuring that the performance of one tenant's activities does not impact other tenants.

AWS Resource Tagging: Use of resource tagging to monitor and allocate resources per tenant, ensuring that one tenant's activities don't impact others.

### 6. Security and Compliance:

Implementing encryption at rest and in transit for each tenant's data.

AWS Key Management Service (KMS): Utilize AWS KMS for encryption at rest and in transit to protect each tenant's data.

### 7. Tenant On-Boarding and Off-Boarding:

Developing a streamlined process for onboarding new tenants, including data migration and configuration setup. Implementing data retention policies and secure data deletion procedures for off-boarding tenants.

AWS Data Migration Services: Simplify tenant onboarding by using AWS Data

Migration Services to migrate data to their dedicated environments.

### 8. Reporting and Analytics:

Providing tenant-specific reporting and analytics, allowing each tenant to gain insights into their revenue cycle independently.

AWS QuickSight: Offer tenant-specific reporting and analytics using

AWS QuickSight to create customized dashboards and visualizations for each tenant.

### 9. Monitoring and Auditability:

Implementing robust monitoring and auditing mechanisms to track user activities, especially in multi-tenant environments.

AWS CloudWatch: Use AWS CloudWatch for centralized monitoring and alerting, with separate dashboards and alarms for each tenant.

AWS CloudTrail: Enable AWS CloudTrail to capture audit logs of API activity for each tenant.

### 10. Billing and Subscription Management:

Developing a billing and subscription management system that allows to manage multiple tenants' payment plans and invoicing.

By addressing these technical considerations and leveraging AWS services, the system can offer a robust and secure multi-tenant platform for revenue cycle management. This ensures data privacy and security while allowing multiple healthcare providers to streamline their financial processes efficiently.

### HIPAA Compliance

The present platform is designed to streamline healthcare revenue cycle management. As a platform handling sensitive patient and medical data compliance with the Health Insurance Portability and Accountability Act (HIPAA) is of paramount importance. Below are key HIPAA compliance considerations for the present system

### 1. Protected Health Information (PHI)

Identification and Classification: Identifying and classifying all Protected Health Information (PHI) handled by the platform, including patient records, billing information, and insurance data.

### 2. Data Encryption

Encryption at Rest: Implementing encryption at rest to protect PHI data. Utilizing AWS Key Management Service (KMS) for encryption key management.

Encryption in Transit: Ensuring data transmission between the present system components and external systems (e.g., Practice Management Systems) is secured using TLS/SSL.

### 3. Access Controls

Role-Based Access Control (RBAC): Enforce strict RBAC to limit access to PHI to authorized personnel only. Utilize AWS Identity and Access Management (IAM) and AWS Cognito for user management.

### 4. Audit Trails

Audit Logging: Creating detailed audit trails for all PHI access and modifications. Enabling AWS CloudTrail to capture and store audit logs.

### 5. Business Associate Agreements (BAAs)

BAAs with AWS and Third Parties: Signing BAAs with AWS and any third party services for ensuring compliance with HIPAA regulations.

### 6. Data Backups and Disaster Recovery

Regular Backups: Implementing regular data backups for ensuring data availability. Developing disaster recovery plans to address system failures or data loss.

### 7. Secure Communication

Secure Channels: Ensuring secure communication channels between the present system components and external systems using TLS/SSL.

### 8. Employee Training

HIPAA Training: Training all personnel who handle PHI on HIPAA regulations and the platform's data protection policies.

By addressing these HIPAA compliance considerations, the system platform can provide a secure and compliant environment for healthcare providers. This ensures the protection of patient data privacy and adherence to legal requirements.

API vs. Web Scraping

If an API is available and meets needs, it's generally recommended to use API integration for its reliability, security, and maintainability. However, if an API is not available or doesn't provide the necessary data, web scraping can be a valuable alternative when used within legal and ethical boundaries.

Below is the comparison between API integration and web scraping based on criteria—

CHART A

| S. | | | |
|---|---|---|---|
| No | Criteria | API Integration | Web-Scraping |
| 1 | Cost | Costlier as it's per API | Generally relatively |
| | | call plus additional cost | cheaper than API |
| | | like Setup fees, annual | integration |
| | | fees etc. | |
| 2 | Amount of | Only specific information | Lot of other information |
| | Data | is received based on API | is also |
| | | call made. | received(Depends |
| | | | upon web-scraping |
| | | | tool). |
| 3 | Data Accuracy | Highly accurate as real | Data accuracy is less |
| | | time data is received | depending upon type of |
| | | | portal and information |
| | | | looked for |
| 4 | Legal | Fully legal as there is | Legality depends upon |
| | consideration | proper agreement | data sharing |
| | | between parties involved | agreement & terms & |
| | | | conditions of |
| | | | particular portal. |
| 5 | Openness | Practice managers are | Generally companies |
| | | open for API integration | are not open for Web- |
| | | | scraping of their |
| | | | portal. Permission |
| | | | needs to be |
| | | | exclusively taken. |
| 6 | Dependencies | No of API calls made | Website Structure |
| | | Failure rates | Data format and structure |
| | | | Authentication & Session |
| | | | handling |
| | | | Data Volume |
| | | | restriction and rate |
| | | | limits |
| | | | Frequency of Data |
| | | | update, |
| | | | dynamic data |
| 7 | General Usage | When Specific | For consolidation of |
| | | information is needed | publicly available data |
| 8 | Example | System can utilize eMDs | The consulting firm |
| | | Healthcare's API to | can deploy web |
| | | securely connect their | scraping techniques to |
| | | EHR system with the | collect data from the |
| | | patient communication | websites of various |
| | | platform's API. | medical practices in |
| | | | the region. This data |
| | | | might include practice |
| | | | names, locations, |
| | | | services offered, and |
| | | | even mentions of |
| | | | practice management |
| | | | software like eMDs, |
| | | | Raintree, or NextGen in |
| | | | the publicly available |
| | | | content on those |
| | | | websites. |
| 9 | Comments | Idle for confidential type | Should be used when |
| | | information | API integration is not |
| | | | available |

For the present system, API integration is one method whereby the system can obtain all required information through API's. APIs are more reliable and provides up-to-date information while adhering to strict security and compliance standards.

In a preferred embodiment, “virtual APIs” implemented using robotic process automation (RPA) and optical character recognition (OCR) techniques to grab data automatically without the need for APIs, although this process looks, acts and feels like APIs. In the present disclosure, API and RPA/OCR are considered interchangeable.

Systems which have full data compatibility include eMDs, eCW, Allscripts, Raintree PrognoCis, CareCloud, Lytec & Athena Health API's.

### API Analysis

Based on current project requirements, required API's can be divided in 3 parts-

### 1. Finance/Transaction Related API:

These APIs are needed for managing financial transactions and billing information. They include details related to patient balances, insurance payments, and other financial aspects. This information is essential for the system core functionality, which involves tracking and managing patient financial data.

### 2. Patient Contact Info API:

These APIs provide access to patient contact and personal information. This category includes details such as patient names, addresses, phone numbers, and email addresses. Patient contact information is vital for sending reminders & communication for dues collection

### 3. Other Info API:

This category likely encompasses APIs that provide additional patient related data or any other information relevant for analytics in the platform. These APIs might offer insights into diagnoses, treatments, or other patient-related details that could be valuable for analytics and reporting within the payment system.

### PMS Example 1

Below summary provides an overview of the key APIs we have analyzed for a first exemplary system including possible endpoints, descriptions, and sample json code output structures.

### Transaction-Related Key API's

### 1. Get Balance Due for Appointments

Description: Retrieves the balance due amount for a specific patient's appointment.
Sample output;

```
jsonCopy code
{
  “copayAmount”: 10.3,
  “balance”; 25.3,
  “dayCopayAmount”: 20.6,
  “dayBalance”: 35.6
}
```

### 2. Get Amount Paid by Insurance

Description: Retrieves the amount paid by insurance for the patient's case.

### Sample Output:

```
jsonCopy code
{
  “priority”: “string”,
  “effectiveFrom”: “string”,
  “effectiveTo”: “string”,
  “caseId”: “string”,
  “subscriberId”: “string”,
  “groupId”: “string”,
  “insurance”: {
    “id”: “string”,
    “name”: “string”
  },
  “subscriber”: {
    “relationship”: “string”,
    “firstName”: “string”,
    “lastName”: “string”,
    “middleName”: “string”,
    “birthSex”: “string”,
    “dob”: “string”,
      “address”: “string”,
      “city”: “string”,
      “state”: “string”,
      “zipCode”: “string”,
      “phone”: “string”
  },
  “copay”: {
      “amount”: “number”,
      “stdCopayType”: “string”
  }
}
```

### 3. Get Payment Results for Patients

Description: Retrieves the payment result (amount paid) by a patent for a specific transaction.

### Sample Output:

```
jsonCopy code
{
  “approved”: true,
  “approvedAmt”: 50.0,
  “transactionId”: “string”
}
```

4. Payment made by Patient

Description: Retrieves details of the payment made by the patient

### Sample Output:

```
jsonCopy code
{
  “approved”: true,
      “approvedAmt”: 50.0,
      “transactionId”: “string”
    }
```

### Contact Information API

### 1. Get Contact Information of Patients

Description: Retrieves contact information for a patient, including personal and professional details.

```
jsonCopy code
{
  “firstName”: “string”,
  “lastName”: “string”,
  “middleName”: “string”,
  “address”: “string”,
  “address2”: “string”,
  “city”: “string”,
  “state”: “string”,
  “zipCode”: “string”,
  “homePhone”: “string”,
  “workPhone”: “string”,
  “cellPhone”: “string”,
  “fax”: “string”,
  “email”: “string”,
  “isProfessional”: true,
  “startDate”: “string”,
  “endDate”: “string”,
  “employer”: “string”,
  “occupation”: “string”,
  “type”: “string”,
  “flags”: [“string”, “string”]
}
```

### PMS Example 2

Below summary provides an overview of the key APIs that the inventors have analyzed for a second exemplary system including possible endpoints, descriptions, and sample output structures based on a tabular information output.

### Transaction-Related Key APIs

### Sample API's Related to Transactions

### 1. Get Claims

Description: Retrieves a list of claims with various details such as charge amount, claim status, patient information, and more.

Output: Detailed information in tabular format.

| | | |
|---|---|---|
| acceptassignmentyn1 | string | Primary accepts assignment. |
| acceptassignmentyn2 | string | Secondary accepts assignment. |
| appointmentid | string | The appointment ID associated with |
| | | this claim. |
| billedproviderid | integer | The provider ID of the billing provider |
| | | for this claim. |
| billedservicedate | string | The billed date of service. |
| chargeamount | string | The total amount billed for all services |
| | | from this claim. |
| claimcreateddate | string | The date the claim was created. |
| claimid | string | internal ID for this claim, specific to the |
| | | practice. |
| currentillnessdate | string | Current illness date. |
| customfields | array | The claim custom field values may or |
| | | may not be the same between |
| | | departments. |
| customfieldid | string | Corresponds to the /customfields |
| | | customfieldid. |
| customfieldvalue | string | For a non-select custom field, the |
| | | value. |
| optionid | string | For a select custom field, the selectid |
| | | value (from /customfield's selectlist). |
| departmentid | integer | The department ID associated with this |
| | | claim. |
| diagnoses | object | Diagnoses is an array of all |
| | | diagnoses. Each entry in the array is a |
| | | hash with several fields. /ccda is a |
| | | better clinical representation. These |
| | | fields are: |
| deleteddiagnosis | string | In certain cases, diagnoses may be |
| | | added and then removed from a |
| | | particular claim. In normal |
| | | circumstances, this will be false. |
| | | However, if a diagnosis was removed, |
| | | this will be true. |
| diagnosiscategory | string | The category for this diagnosis. |
| diagnosiscodeset | string | Either ICD9 or ICD10. |
| diagnosisdescription | string | A description of this diagnosis. |
| diagnosisid | string | A unique ID related to this diagnosis. |
| diagnosisrawcode | string | The raw ICD [symbol] 9 code. This will migrate |
| | | to ICD [symbol] 10 in the future. |
| fromunabletoworkdate | string | Patient unable to work from date. |
| lastmodified | string | Last modified date. |
| lastmodifiedby | string | Last modified by user. |
| localpatientid | integer | The local patient ID associated with this |
| | | claim. |
| medicaidresubmissioncode | string | Resubmission, Code. |
| medicaidresubmissionorigrefno | string | Resubmission Original Ref No. |
| medicaresecondaryqualifier | string | Medicare as a Secondary Payer |
| | | qualifier selection name. |
| medicaresecondaryqualifierid | string | Medicare as a Secondary Payer |
| | | qualifier selection Id. |
| patientid | integer | The patient ID associated with this |
| | | claim. |
| patientpayer | object | The status and notes of a responsible |
| | | payer. This payer is the patient. |
| balance | paymentamount | Outstanding balance from patient for |
| | | this claim. |
| note | string | The note that is attached to this status. |
| status | string | The status associated with this |
| | | responsible payer. |
| primaryinsurancepayer | object | The status and notes of a responsible |
| | | payer. This payer is the primary |
| | | insurance. |
| balance | paymentamount | Outstanding balance from primary |
| | | insurance for this claim. |
| note | string | The note that is attached to this status. |
| primaryinsurancepackageid | integer | The primary insurance Package id |
| | | associated with this claim. |
| primarypatientinsuranceid | integer | The primary insurance id associated |
| | | with this claim. |
| status | string | The status associated with this |
| | | responsible payer. |
| procedures | object | Procedures is an array of all |
| | | procedures. /ccda is a better clinical |
| | | representation. These fields are: |
| allowableamount | string | The total amount expected from payer |
| | | for all services from this procedure. |
| allowablemax | string | The maximum amount expected from |
| | | payer for all services from this |
| | | procedure. |
| allowablemin | string | The minimum amount expected from |
| | | payer for all services from this |
| | | procedure. |
| chargeamount | string | The amount charged for this |
| | | procedure. |
| procedurecategory | string | The category name associated with |
| | | this procedure. |
| procedurecode | string | The CPT code associated with this |
| | | procedure. |
| proceduredescription | string | A description of this procedure. |
| servicetypeaddons | array | Array of service type add-ons |
| | | STAOs) for the charge. |
| fields | array | |
| fieldname | string | Service type add-on field name. |
| fieldvalues | array | |
| identifier | string | Service type add-on identifier. |
| transactionid | string | The ID of the last transaction associated |
| | | with the claim. |
| referralauthid | integer | The referral authorization ID for this |
| | | claim. |
| referringproviderid | integer | The referring provider ID for this |
| | | claim. See /referringproviders. This is |
| | | not the same as the ID from |
| | | the /providers call. |
| relatedtoautoaccidentyn | string | Patient's condition related to accident. |
| relatedtoemploymentyn | string | Patient's condition related to |
| | | employment. |
| relatedtootheraccidentyn | string | Patient's condition related to other |
| | | accident. |
| renderingproviderid | string | Rendering provider. |
| reserved10d | string | Reserved (10d) (remarks). |
| reserved19 | string | The text in the Reserved 19 field. |
| schedulingproviderid | string | Scheduling provider. |
| secondaryinsurancepayer | object | The status and notes of a responsible |
| | | payer. This payer is the secondary |
| | | insurance. |
| balance | paymentamount | Outstanding balance from secondary |
| | | insurance for this claim. |
| note | string | The note that is attached to this status. |
| secondaryinsurancepackageid | integer | The secondary insurance package id |
| | | associated with this claim. |
| secondarypatientinsuranceid | integer | The secondary insurance id |
| | | associated with this claim. |
| status | string | The status associated with this |
| | | responsible payer. |
| servicetypeaddons | array | Array of service type add-ons |
| | | STAOs) for the claim. |
| fields | array | |
| fieldname | string | Service type add-on field name. |
| fieldvalues | array | |
| identifier | string | Service type add-on identifier. |
| signatureonfileassignmentbenefits | string | Status of signature on file for |
| | | assignment of benefits. |
| signatureonfilereleaseinformation | string | Status of signature on file for release |
| | | of billing information. |
| signaturesourcecode | string | Signature source. |
| similarillnessdate | string | Same or similar illness date. |
| supervisingproviderid | integer | The supervising provider ID for this |
| | | claim. |
| supervisingprovidername | string | The supervising provider name for this |
| | | claim. |
| tounabletoworkdate | string | Patient unable to work to date. |
| transactiondetails | object | A hash of ids (“transactionid”) to |
| | | amounts; these should sum to the |
| | | chargeamount. |
| transactionid | string | A unique ID for the primary |
| | | transaction this claim represents. May |
| | | be useful for debugging. |

### 2. Get Patient Outstanding Detailed Claims

Description: Retrieves a full view of a patient's open claims, including charge details, transactions, claim notes, and outstanding balances.

Output: Detailed information in Tabular Format

| | | |
|---|---|---|
| claims | array | The open claims held by the patient in |
| | | this provider group. |
| chargeleveldetails | array | Detailed information on charges |
| | | associated with the claim. |
| amount | paymentamount | The billed amount for the charge. |
| chargeid | integer | The Internal ID of the charge. |
| description | string | Description of the service. |
| primaryinsurancepackagename | string | The primary insurance of the patient |
| | | used for the claim. |
| primaryselfpayyn | string | Whether the primary insurance is self |
| | | pay |
| procedurecodeothermodifier | string | Modifiers for the procedure code |
| providername | string | The name of the provider who |
| | | rendered the service. |
| secondaryinsurancepackagename | string | The secondary insurance of the |
| | | patient used for the claim. |
| secondaryselfpayyn | string | Whether the secondary insurance is |
| | | self pay |
| servicedate | string | Date of service for the charge. |
| statementdescription | string | Description of the service as it |
| | | appears on a statement |
| supervisingprovidername | string | The name of the supervising provider |
| | | who rendered the service. |
| transactions | array | Detailed information on transactions |
| | | associated with the charge. |
| amount | paymentamount | The amount associated with the |
| | | transaction. |
| date | string | The date of the transaction. |
| description | string | Information related to the type of |
| | | transaction. For example, a co- pay.). |
| epaymentid | integer | The epayment ID of the payment |
| | | receipt associated with this payment |
| | | transaction. Applicable only for e- |
| | | payments. |
| epaymentpatientid | integer | Internal ID of the patient that made |
| | | the payment |
| transactionid | integer | The internal ID of the transaction. |
| transfertype | string | The party responsible for the parent |
| | | charge of this transaction. For |
| | | example, ‘1’ (primary), ‘2’ |
| | | (secondary), or ‘p’ (patient). |
| type | string | The type of the transaction. For |
| | | charge, payment, adjustment, etc. |
| claimid | integer | The claim ID. |
| claimnotes | array | Claim notes |
| action | string | Action type for this note. |
| claimstatus | string | Claim status as of this note. |
| created | string | Creation date for the note. |
| note | string | Note text. May include basic HTML |
| | | formatting. |
| transfertype | string | Transfer type for this note 1, 2, or p). |
| collectionyn | string | Whether the claim is in collection. |
| departmentid | integer | The department ID for the claim. |
| outstanding | paymentamount | The outstanding balance. |
| patientfirstname | string | The patient name. |
| patientid | integer | The patient ID. |
| patientlastname | string | The patient name. |
| patientpayable | string | Whether the balance is patient payable. |
| paymentplanid | integer | The ID of the payment plan that the |
| | | claim is in, if any. |
| servicedate | string | The date the service was rendered. |

### Contact Information Related API

### 1. Get Patient Information

Description: Retrieves contact and personal information for a specific patient, including details such as name, contact information and payment plan status.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the allowed claims.

What is claimed is:

1. A payment collection prediction system utilizing one or more of artificial intelligence as well as machine and learning models to predict payment confidence and payment collection cost analysis and to thus optimize customer communication and estimate collection amounts versus collection costs, the system comprising:
means for retrieving or receiving customer information data related to at least one customer interaction with at least one vendor;
means for retrieving or receiving billing data related to said at least one customer and said at least one vendor;
means for retrieving or receiving demographic data related to said at least one customer; and
means, responsive to said retrieved or received customer information, said retrieved or received billing data and to said retrieved or received demographic data related to said at least one customer, for computing a prediction for said at least one customer to pay said billing data and for said vendor to collect a billed amount related to said at least one customer and said at least one vendor.

2. A payment collection prediction method utilizing one or more of artificial intelligence and machine and learning models to predict payment confidence and payment collection cost analysis and to thus optimize customer communication and estimate collection amounts versus collection costs, the method comprising:
retrieving or receiving customer information data related to at least one customer interaction with at least one vendor;
retrieving or receiving billing data related to said at least one customer and said at least one vendor;
retrieving or receiving demographic data related to said at least one customer; and
responsive to said retrieved or received customer information, said retrieved or received billing data and to said retrieved or received demographic data related to said at least one customer, computing a prediction for said at least one customer to pay said billing data related to said at least one customer and said at least one vendor.

3. The method of claim 2, wherein said vendor is a health care provider.

4. The method of claim 3, wherein said customer is a patient receiving health care from said health care provider.

5. A payment collection system comprising:
a transaction logging module configured to record patient payment attempts, outcomes, and associated channel costs;
a feature extraction module configured to update a dataset based on said recorded outcomes;
a prediction module trained on said updated dataset to generate payment propensity scores;
a cost analysis module configured to compute expected yield for communication channels; and
a policy engine configured to select a communication channel based on said propensity score and expected yield, wherein said prediction module is continuously updated using said recorded outcomes.

6. The system of claim 5, wherein said outcomes comprise full payment, partial payment, delayed payment, or default.

7. The system of claim 5, wherein said policy engine applies regulatory and consent-based constraints including maximum contact frequency and channel permissions.

8. The system of claim 5, wherein said vendor is a healthcare provider and said customer is a patient.

9. A payment collection system comprising:
an RPA/OCR integration module, configured to log into a PMS/EHR system, to retrieve pre-built financial reports, and parse said reports into structured data;
a prediction engine, responsive to said RPA/OCR integration module, configured to compute payment propensity scores using said structured data; and
an RPA/OCR posting module configured to enter payment transactions back into said PMS/EHR.

10. The system of claim 9, wherein said structured data is normalized into a schema equivalent to a standards-based API output.

11. The system of claim 9, wherein said RPA/OCR posting module enables bidirectional workflows without reliance on native API integration.

12. The system of claim 9, wherein said integration enables a healthcare provider to be fully operational within less than one week with minimal IT resources.

13. The system of claim 5, wherein said prediction module is trained using online learning techniques selected from the group consisting of stochastic gradient descent, Thompson sampling, LinUCB bandits, and ensemble incremental updates.

14. The system of claim 5, wherein said transaction logging module stores events in an append-only, hash-protected ledger to preserve auditability and model integrity.

15. The system of claim 5, wherein said cost analysis module determines expected yield using historical communication costs and patient-specific response patterns.

16. The system of claim 5, wherein said system supports multi-tenant deployments with segregated data storage and configurable workflows.

17. A payment collection prediction system utilizing one or more of artificial intelligence as well as machine and learning models to predict payment confidence and payment collection cost analysis and to thus optimize customer communication and estimate collection amounts versus collection costs, the system comprising:
a customer information data receiver and data storage device, said customer information data related to at least one customer interaction with at least one vendor;
a customer billing data receiver and data storage device, said customer billing data related to said at least one customer and said at least one vendor;
a demographic data receiver and data storage device, said demographic data related to said at least one customer; and
a computerized customer prediction to pay device, responsive to said received and stored customer information data, said received and stored billing data and to said received and stored demographic data, all related to said at least one customer, for computing a prediction for said at least one customer to pay said billing data related to said at least one customer and said at least one vendor.

18. The system of claim 17, wherein said vendor is a health care provider.

19. The system of claim 18, wherein said customer is a patient receiving health care from said health care provider.
